(19) United States
(12) Patent Application Publication
(10) Pub. No.: US 2007/0214055 A1
(43) Pub. Date: Sep. 13, 2007

(54) System for beverage dispensing and sales tracking

(76) Inventor: Seth Temko, Prospect Heights, IL (US)

Correspondence Address: ADELI LAW GROUP, A PROFESSIONAL LAW CORPORATION, 1875 CENTURY PARK EAST, SUITE 1360, LOS ANGELES, CA, 90067, US

(21) Appl. No.: 11/368,341

(22) Filed: Mar. 4, 2006

(51) Int. Cl. G06Q 20/00

(52) U.S. Cl. 705/22

(57) ABSTRACT

Some embodiments provide a system for beverage dispensing and sales tracking. The system includes a data manager, a data store, and one or more sales nodes. In some embodiments, the data manager includes a point-of-sale server function. In some embodiments, the data manager obtains information from the sales nodes related to pouring of beverages, such as liquor. This information may include (1) who poured the drink, (2) where it was poured, (3) when it was poured, and (4) how much was poured. The data manager uses this information to maintain an accurate inventory of beverages and for billing beverage customers. The data manager stores and manipulates this information in the data store.

### FIELD OF THE INVENTION

The invention is directed towards a system for beverage dispensing and sales tracking.

### BACKGROUND OF THE INVENTION

It is well known that the dispensing of beverages, particularly expensive liquor, must be carefully monitored to avoid waste and loss. The management of establishments that sell beverages, for example, hotels, restaurants, bars, or night clubs, have long found it necessary to carefully monitor the relationship between liquid purchased and dispensed and the resulting receipts by controlling the quantity of liquid dispensed from a specific container and recording the sale.

Such establishments would also like to maximize their cash flow and profit by obtaining more information about the complete history of the life cycle of the container and the beverage it contains. This history can be used in several ways including: (1) optimizing inventory turnover rate to minimize inventory and thus optimize cash flow, (2) improve accounting reconciliation of inventory versus purchases and sales receipts, (3) cutting employee direct theft, and (4) aid in product recalls and related product safety issues. However, this life cycle information has been very difficult to obtain because of the lack of any means to identify and track individual beverage containers. Without this individualization, all cases of the same product, for example, would be indistinguishable to the purchaser. The purchaser, then, would not be able to, for example, select the oldest stock to use first or identify which cases a product recall applied to without giving up the entire stock of a particular product.

Accordingly, there is a need for a system for beverage dispensing and sales tracking that automatedly maintains a history of each container as it is transported from a manufacturing plant to a manufacturing warehouse, to a distribution warehouse, to a shipping warehouse, to a delivery truck, and to a warehouse or storeroom at the retail establishment at which the container is ultimately sold. There is also a need for such a system to relate each beverage serving to where and when it was served and who served it. There is also a need to automatically account for each serving from beverage inventory, and relating the serving to a customer account.

### SUMMARY OF THE INVENTION

Some embodiments provide a system for beverage dispensing and sales tracking. The system includes a data manager, a data store, and one or more sales nodes. In some embodiments, the data manager includes a point-of-sale server function. In some embodiments, the data manager obtains information from the sales nodes related to pouring of beverages, such as liquor. This information may include (1) who poured the drink, (2) where it was poured, (3) when it was poured, and (4) how much was poured. The data manager uses this information to maintain an accurate inventory of beverages and for billing beverage customers. The data manager stores and manipulates this information in the data store.

In some embodiments, when a sales area is restocked with a container, the container is placed in one of several particular stocking locations in the sales area. When the container is placed in the particular area, its RFID tag is read by a container receptacle, and the data read is sent to the data manager. In some embodiments, container tags are also read when a pour monitoring device (PMD), such as a spout, is installed on the container, when the container is poured, and, finally, when an empty container is discarded.

Thus, the information provided by an RFID tag attached to a beverage container and written/read at various stages of its transportation and use provides a complete history of the life cycle of the container and the beverage it contains. This history can be used in several ways including: (1) optimizing inventory turnover rate to minimize inventory and thus optimize cash flow, (2) improve accounting reconciliation of inventory versus purchases and sales receipts, (3) cutting employee direct theft, and (4) aid in product recalls and related product safety issues.

### BRIEF DESCRIPTION OF THE DRAWINGS

The novel features of the invention are set forth in the appended claims. However, for purpose of explanation, several embodiments of the invention are set forth in the following figures.

FIG. 1 illustrates a system for beverage dispensing and sales tracking of some embodiments.

FIG. 2 illustrates a system architecture for beverage dispensing and sales tracking and the subsystems in a sales node.

FIG. 3 illustrates a sale process of some embodiments.

FIG. 4A illustrates RFID tags of a beverage container of some embodiments.

FIG. 4B illustrates PMDs of a beverage container of some embodiments.

FIG. 5 illustrates a process for pouring drinks in some embodiments.

FIG. 6 illustrates the components of a scanning pad and container receptacle tracking of some embodiments.

FIG. 7 illustrates a process for scanning pad and container receptacle operation in some embodiments.

FIG. 8 illustrates the components of a data device of some embodiments.

FIG. 9 illustrates a process of tracking the life cycle of a container.

FIG. 10 illustrates a computer system that can be used in conjunction with some embodiments of the invention.

### DETAILED DESCRIPTION OF THE INVENTION

In the following description, numerous details are set forth for purpose of explanation. However, one of ordinary skill in the art will realize that the invention may be practiced without the use of these specific details. In other instances, well-known structures and devices are shown in block diagram form in order not to obscure the description of the invention with unnecessary detail.

Some embodiments provide a system for beverage dispensing and sales tracking. The system includes a data manager, a data store, and one or more sales nodes. In some embodiments, the data manager includes a point-of-sale server function. In some embodiments, the data manager obtains information from the sales nodes related to pouring of beverages, such as liquor. This information may include (1) who poured the drink, (2) where it was poured, (3) when it was poured, and (4) how much was poured. The data manager uses this information to maintain an accurate inventory of beverages and for billing beverage customers. The data manager stores and manipulates this information in the data store.

The data manager obtains the pouring information as well as information pertaining to the location of inventory by automatedly obtaining information from electronic identification devices (EIDs) attached to beverage containers, cases and pallets. The term automatedly, as used in this application, refers to a process that occurs periodically, without human intervention or initiation. An EID can communicate to an external systems the unique identification of the container to which it is attached as well as additional information pertaining to the container. In some embodiments, an EID may be a passive (not self-powered) or active (self-powered) device and may or may not obtain information from as well as provide information to an external system. In some embodiments, the EID is a Radio Frequency Identification (RFID) tag.

In some embodiments, when a sales area is restocked with a container, the container is placed in one of several particular stocking locations in the sales area. When the container is placed in the particular area, its RFID tag is read by a container receptacle, and the data read is sent to the data manager. In some embodiments, container tags are also read when a pour monitoring device (PMD) is installed on the container, when the container is poured, and, finally, when an empty container is discarded.

Thus, the information provided by an RFID tag attached to a beverage container and written/read at various stages of its transportation and use provides a complete history of the life cycle of the container and the beverage it contains. This history can be used in several ways including: (1) optimizing inventory turnover rate to minimize inventory and thus optimize cash flow, (2) improve accounting reconciliation of inventory versus purchases and sales receipts, (3) cutting employee direct theft, and (4) aid in product recalls and related product safety issues.

Several more detailed embodiments of the invention are described in sections below. Before describing these embodiments further, an overview of these embodiments is given in Section I below. Section II describes the system architecture of the beverage dispensing and sales tracking system of some embodiments. Section III describes several alternate embodiments of several aspects of the invention. These aspects include alternate capabilities of the data collection hardware portions of the system and methods for RFID tag movement and speed determination. Finally, Section IV describes a computer system with which some embodiments of this invention is implemented.

### I. Overview

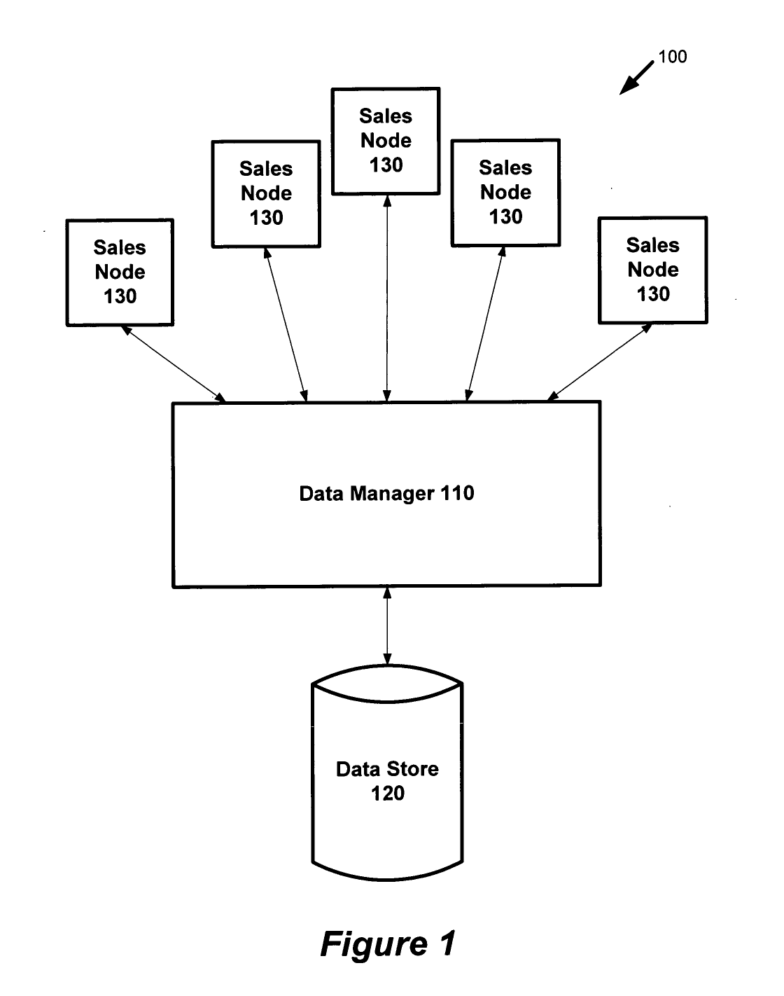

FIG. 1 illustrates a system for beverage dispensing and sales tracking 100 of some embodiments. As shown in this figure, a system for beverage dispensing and sales tracking includes a data manager 110, a data store 120, and one or more sales nodes 130. In some embodiments, the data manager includes a point-of-sale server function.

In some embodiments, the data manager 110 obtains information from the sales nodes 130 related to pouring of beverages, such as liquor or soft drinks. This information may include (1) who poured the drink, (2) where it was poured, (3) when it was poured, and (4) how much was poured. The data manager uses this information to maintain an accurate inventory of beverages and for billing beverage customers. The data manager 110 stores and manipulates this information in the data store 120. The following sub-sections describe how this information is used for beverage inventory determination, sales tracking and sales completion.

A. Inventory Determination

Businesses that sell beverages typically receive shipments of cases of containers of beverages at a warehouse or receiving dock. Some particularly expensive beverages, such as some wines and liquors, may be received as individual containers. The individual containers as well as pallet loads of cases and/or individual cases may each have a Radio Frequency IDentification (RFID) tag.

An RFID tag is a small object that can be attached to or incorporated into an object. RFID tags contain antennas to enable them to receive and respond to radio-frequency queries from an RFID transceiver. RFID tags can be writable, read-only, or a combination. In a writeable tag, stored data can be changed. In a read-only tag, stored data can be read but not modified. Some tags may be a combination of read-only and writeable, i.e., some data is permanently stored while the rest of the memory is left accessible for later updates.

Information stored on the tag can potentially provide a history of each container as it is transported from a manufacturing plant to a manufacturing warehouse, to a distribution warehouse, to a shipping warehouse, to a delivery truck, and to a warehouse or storeroom at the retail establishment at which the container is ultimately sold.

At the point of receipt at the retail establishment, such as a warehouse or backroom storage area, the tag is read by an RFID tag reader and the information from the tag is stored in an inventory data store. The information read from the tag may include:
A unique identification number per pallet and/or case
Manufacturer of the beverages
Location of the manufacturing plant
Type of liquid, e.g., Jack Daniel's®
Size of container, e.g., in liters
Date/time of manufacture
Date/time of each step of the container's transportation
The ambient temperature and humidity at each transportation destination
Number of containers per case
Number of cases in the shipment

In some embodiments, this information is transferred, when read, to a data manager 110 that stores and processes inventory information.

Areas of the business in which drinks are sold, are restocked with containers from the inventory. Unopened containers stored in a sales area are referred to as par stock. In some embodiments, each beverage container carries an RFID tag containing data such as:
A unique identification number of the container
Manufacturer name/ID
Manufacturing site
Type of liquid
Quantity of liquid in the container, e.g., in liters
Date/time of manufacture
Date/time of each step of the container's transportation
The ambient temperature and humidity at each transportation destination

In some embodiments, when a sales area is restocked with a container, the container is placed in one of several particular par stock locations in the sales area. When the container is placed in the particular area, its RFID tag is read by a container receptacle, described below, and the data read is sent to the data manager. In some embodiments, container tags are also read when a PMD is installed on the container, when the container is poured, and, finally, when an empty container is discarded.

Thus, the information provided by an RFID tag attached to a beverage container and written/read at various stages of its transportation and use provides a complete history of the life cycle of the container and the beverage it contains. This history can be used in several ways including: (1) optimizing inventory turnover rate to minimize inventory and thus optimize cash flow, (2) improve accounting reconciliation of inventory versus purchases and sales receipts, (3) cutting employee direct theft, and (4) aid in product recalls and related product safety issues.

The value of this historical data is enabled by the individualization of pallets, cases and containers. Without this individualization, all cases of the same product, for example, would be indistinguishable to the purchaser. The purchaser, then, would not be able to, for example, select the oldest stock to use first or identify which cases a product recall applied to without giving up his entire stock of a particular product. With individualization, in some embodiments, the entire life cycle of a container can be available, that is, for example:
When the container came into storage
When the container came out of storage
When the container became par stock at, e.g., a bar
When the container, e.g., a bottle, was deployed with a PMD
When the empty container was discarded

This life cycle of events parallels the flow of money that changes hands during the purchase and sale of beverages:
Payment on receipt of containers placed in storage
Cash value of containers in storage
Value of containers deployed out of storage to par stock in a service area
Value of containers in par stock eventually consumed, reflected in sales tracking
End of value when a container is emptied and discarded

Knowing the details of this cash flow allows the retail establishment to reconcile all transactions for each container from initial purchase to discard. The resulting information allows the establishment to obtain maximum profitability from their operations. For example, multiple shipments of one type of beverage may be in storage. With the historical information available from RFID tags on the containers, the data manager 110 of some embodiments can use the oldest stock first, reducing inventory and the cash it represents to the minimum. In some embodiments, the data manger can also keep track of usage patterns and automatically place orders to replenish stock, thus implementing just-in-time restocking methods. This historical information can also provide the retail establishment or advertising agency with data to determine which beverage brands are popular and which are unpopular.

Many of the benefits of the use of this history can accrue to the retail sales establishment such as a hotel, restaurant, bar or night club. These benefits can apply to the sale of any type of beverage but are particularly advantageous in the sale of high-margin alcoholic beverages. For example, when a beverage sales person (such as a server, waiter, or bar tender), needs a new container, he/she removes it from the par stock location, opens the container, and installs a PMD, such as a spout, to monitor pouring. In some embodiments, the PMD reads the RFID tag on the container, as well as a personal identification tag carried by the bar tender, and sends the container and personal tag information, as well as the PMD's own ID to the data manager 110. The data manager now knows (1) in which sales area the container is being used, (2) the ID of the container, (3) what PMD is associated with the container, and (4) who attached the PMD.

Thus, in the manner described above, the data manager obtains the information needed to subsequently track pours from the container, as described below. The data manager uses this information to update the inventory. The data manager subtracts amounts poured from a particular container from the original amount contained in the container, which was stored in the data store 120.

B. Sales Tracking

After a PMD is attached to a container and the container is opened, the data manager 110 receives data from the PMD every time the beverage is poured from the container. The data manager also receives an indication every time a container is moved from one storage location to another in a sales area. This data is used by the data manager to track the amount poured, as well as who poured it, and when and where it was poured.

In some embodiments, the amount poured is computed by the data manager based on the time the container is tilted into a pouring position. Each time the container is tilted for pouring, or returned to an upright position, the spout reports the angle of tilt to the data manager. The data manager computes the amount poured based on the tilt angle and duration of time that the container was at that angle.

The PMD also reports the:
The ID of the person who poured
The container ID
The PMD ID

In some embodiments, the PMD reports the amount poured based on the angle and duration of a pour. In some embodiments, the PMDs are free-pour spouts, allowing liquid to be poured without restricting flow or limiting quantities. In other embodiments, the PMDs are restricted pour spouts, limiting liquid to be poured to a certain per-determined quantity. Detailed descriptions of the above mentioned spout functions is described in the U.S. Pat. No. 6,892,166, entitled “Method, Apparatus, and System for Monitoring Amount of Liquid Poured from Liquid Containers” issued on May 10, 2005 and U.S. Pat. No. 6,036,055 entitled, “Wireless Liquid Portion and Inventory Control System” issued on Mar. 14, 2000. These two applications are fully incorporated herein by reference. One of ordinary skill in the art will recognize that other combinations of reported data and PMD and data manager computation could be used to derive the amount poured.

C. Sales Completion

The information from the PMD, listed above, is subsequently used to complete the sale by charging the pour to the proper account. The data manager selects the proper account based on the ID of the person who poured and the location of the serving area. The serving area is determined from the container receptacle from which the reported container had been stored.

As described above, the data manager acquires the serving area location of each container and the ID of the person who poured the container. Using this information, the data manager of some embodiments can direct the computed amount of the pour to a Point-Of-Sale (POS) terminal in the associated serving area. In some embodiments, the POS terminal provides the beverage sales person with a user interface (such as a touch screen display) local to his/her serving area. The sales person uses the POS terminal to associate pours with accounts that he is serving, as well as to print checks and receipts. Ultimately, the account is closed, and a check is. generated for payment which contains charges for all of the pours purchased by the account.

### II. System Architecture

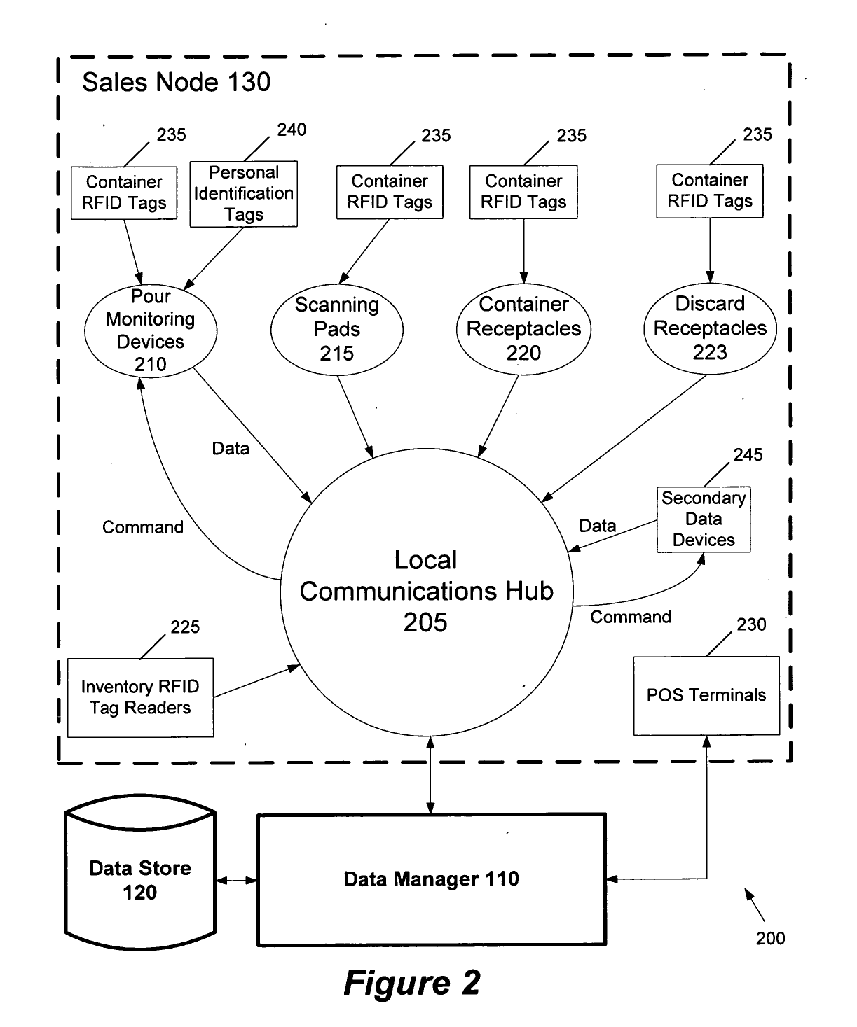

FIG. 2 illustrates a system architecture 200 of a beverage dispensing and sales tracking system of some embodiments of the invention. This figure shows the data manager 110 and subsystems within one of the sales nodes 130. As shown in FIG. 2, a sales node 130 includes a local communications hub (LCH) 205. The sales node 130 also includes a set of data collection devices local to the particular sales node 130. As shown, these data collection devices include PMDs 210, scanning pads 215, container receptacles 220, discard receptacles 223, secondary data devices (such as devices reporting temperature or humidity) 245, inventory RFID tag readers 225, POS terminals 230, container RFID tags 235, and personal identification tags (PITs) 240.

Each of these components will be described in detail, below, in conjunction with the several functional aspects of the beverage dispensing and sales tracking system. These aspects include (1) inventory data management, (2) sales processing, (3) data communications, and (4) pour tracking.

A. Inventory Data Management

As introduced above, the beverage dispensing and sales tracking system collects data regarding beverages that arrive into inventory, the quantity of beverages that are removed from inventory, costs and charges accrued, etc. The data manager maintains a data store 120, in a data storage device, of all such information and coordinates the functions of the various subsystems in a particular application.

The data manager 110 receives data from each local group of data collection devices including PMDs 210, scanning pads 215 and container receptacles 220. The data manager also receives data from a set of inventory RFID tag readers 225 in the warehouse or backroom storage area. The data manager typically acquires this data from one or more LCHs 205 which are communicatively coupled to these data collection devices. The data manager may also have an interface to one or more POS terminals 230, located in each sales node. The computer running the data manager software may have a wired or wireless LAN connection to the LCHs.

In some embodiments, the data store maintained by the data manager includes data such as:
Container data
   ID
   name of beverage
   quantity per container
   current amount remaining
   cost per container
   ID of currently associated PMD
PMDs
   Associated container ID
   When placed on container
   When removed from container
   When poured
   How much poured for each pour
Personal Identification Tags, for each employee
   Employee ID
   Work schedule
   Time in/out
   Work location
Inventory
   Description and quantity of all containers in inventory
   Costs
   Status of each container, e.g., in use, empty, etc.

In some embodiments, the data manager also incorporates a POS server function. In this role, the data manager integrates data of amount poured, the pour location and the person who made the pour to direct the computed charge to the correct POS terminal and the correct group of tabs for ringup by a sales person. The amount poured is deducted from inventory. The total sale is received from the POS terminal and stored in a portion of the data store that could later be provided to an accounting system.

In some embodiments, the data manager stands alone, that is, includes the functions of a POS terminal (as well as POS server function). A stand-alone data manager directly interfaces to one or more of the subsystem interfaces as shown in FIG. 2. In other embodiments, the data manager also assumes the functions of an LCH. In some embodiments, the data manager communicates with and collects data from several LCHs and several POS terminals. One of ordinary skill in the art will recognize that the data management and point-of-sale server functions could be distributed in several ways depending on the number and size of sales areas and the POS functions required for a particular application.

B. Sales Processing

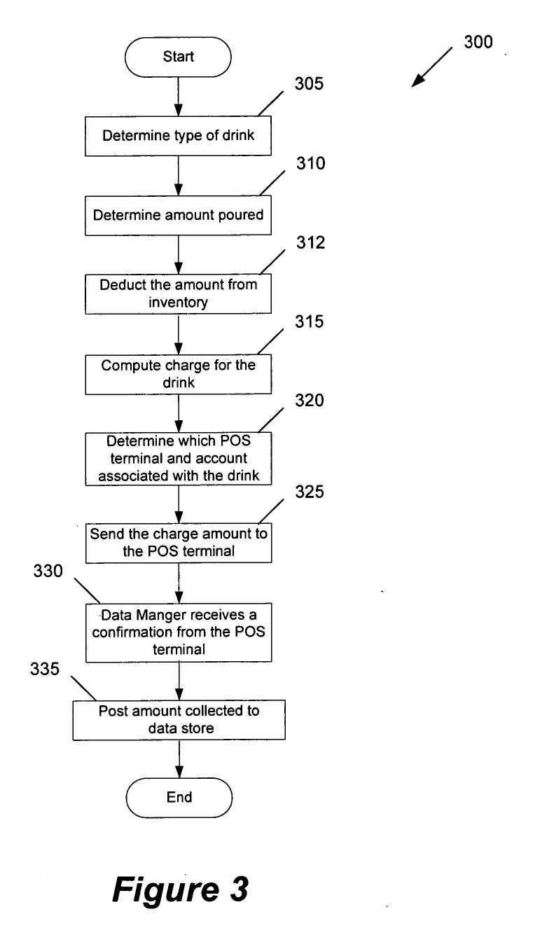

FIG. 3 illustrates a process 300 used by the data manager 110 of some embodiments to do sales processing. Processing a sale includes six steps: (1) determining the type of drink and beverage poured for a particular drink, (2) determining the amount poured and deducting it from inventory, (3) computing the charge based on the nominal charge for the particular drink, (4) determining which POS terminal and account should receive the charge, (5) sending the charge amount to the POS terminal, and (6) receiving confirmation of the charge to a particular tab (ringup) and posting the amount collected to the data store for accounting.

As shown in FIG. 3, process 300 determines (at 305) the type of drink ordered. The type of drink is determined from an order placed by beverage sales person (e.g., a bar tender) via a POS terminal 230. When the sales person makes one or more pours associated with the drink, she first picks up a container. In some embodiments, when she tilts the container to pour, the PMD provides information, via an LCH, to the data manager 110. The information includes the sales person ID, the container ID and the length of time of the pour. Details of PMD operation are further described below. The container ID is used as an index to look up in the data store 120 the type of beverage poured.

Next (at 310), the process 300 determines the amount poured. As described above, in some embodiments, the amount of liquid poured is determined from the time poured and the angle of the container during that time. The process deducts (at 312) the amount poured from inventory. The data manager (at 315) computes the charge for the drink from the POS-entered type of drink and the amounts of constituent pours.

Next (at 320) the process determines the correct POS terminal 230 to send the charge to. In some embodiments, the POS terminal is determined from the work location of the sales person who poured the drink. In other embodiments, the POS terminal is determined from a container receptacle 220 from which the container poured was originally stored.

The process 300 then sends (at 325) the proper charge amount to the POS terminal 230. After all pours for a drink have been completed, the person serving the drink delivers it to the guest and rings up the sale. In the process of ringing up the sale, the beverage sales person associates all constituent pours with the drink and the proper charge amount. In some embodiments, ring up of the sale causes the data manager 110 to reconcile the amounts of the constituent pours from data collected prior to ring up. When the sales person receives payment from the account, the data manager receives (at 330) a confirmation from the POS terminal. In some embodiments, the POS terminal 230 is directly connected to the data manager computer via a wired or wireless LAN connection. In other embodiments, the data manager computer may serve the function of a stand-alone POS terminal. Finally (at 335), the sales amount is posted to the data store 120 for subsequent accounting.

C. Data Communications

The LCH 205 is an interface between the data manager 110 and other devices (such as PMDs 210, container receptacles 220, etc.) local to a particular sales area. In some embodiments, the LCH interfaces to the data manager via a hardwired LAN, e.g., Ethernet, or by a wireless communications interface, e.g., IEEE 802.11g, WiFi. The LCH hardware includes RF transceivers for communications with several PMDs 210, scanning pads 215, container receptacles 220, discard receptacles 223, and secondary data devices 245. Alternatively, in some embodiments, the scanning pads and container receptacles may have a hardwired connection to the LCH.

The function of the LCH 205 is to act as an interface between the data manager computer and the set of data collection devices local to a particular sales node (sales area of transaction). In embodiments of the system in which the data manager does not operate stand-alone, the LCH is required to communicate with wireless devices, such as PMDs 210 and scanning pads 215 and pass the data to the data manager. This is because (1) the short range of the type of transmitters of some embodiments of the local wireless devices may not reliably reach a central location of the data manager computer, and (2) the LCH can buffer the large number of short transmissions from many devices such as local PMDs, scanning pads and container receptacles, sending the data to the data manager in longer packets. This relieves the data manager of the overhead of handling many small, real-time, transmissions, especially when the data manager is handling transactions with a large number of LCHs in many sales nodes.

The LCH 205 includes hardware for wired or wireless communications with the data manager, and, separately, with wired or wireless local data collection devices (PMDs or container receptacles, etc.). In particular, the PMDs 210 must communicate wirelessly with the LCH with a low-power transmitter commensurate with their limited battery power capacity.

An LCH 205 can also initiate a communication with secondary data devices 245 if data is needed from a sensor in a secondary data device. One example of a sensor in such a data device of some embodiments is a temperature sensor that provides the ambient temperature of the environment in which the device is situated. This may be useful, for instance, to determine that a particular batch of wine is kept at the proper temperature.

D. Pour Tracking

As described above, the data manager 110 tracks pours as part of sales processing. The data that the data manager collects to accomplish this tracking is derived from several sources: (1) PMDs 210 reading container and personal tags, (2) scanning pads 215 reading container tags, and (3) container receptacles 220 reading container tags. The following sections describe several methods of tracking by means of containers and attached EIDs and PMDs. Details of several pour tracking systems are described in the concurrently filed U.S. patent application, Attorney Docket No. CPTN.P0005, entitled “Method, Apparatus, and System for Monitoring Amount of Liquid Poured from Liquid Containers,” filed on Mar. 4, 2006, and the concurrently filed U.S. patent application, Attorney Docket No. CPTN.P0007, entitled “Method, Apparatus, and System for Monitoring Amount of Liquid Poured from Liquid Containers,” filed on Mar. 4, 2006. These two applications are fully incorporated herein by reference.

1. Container EIDs

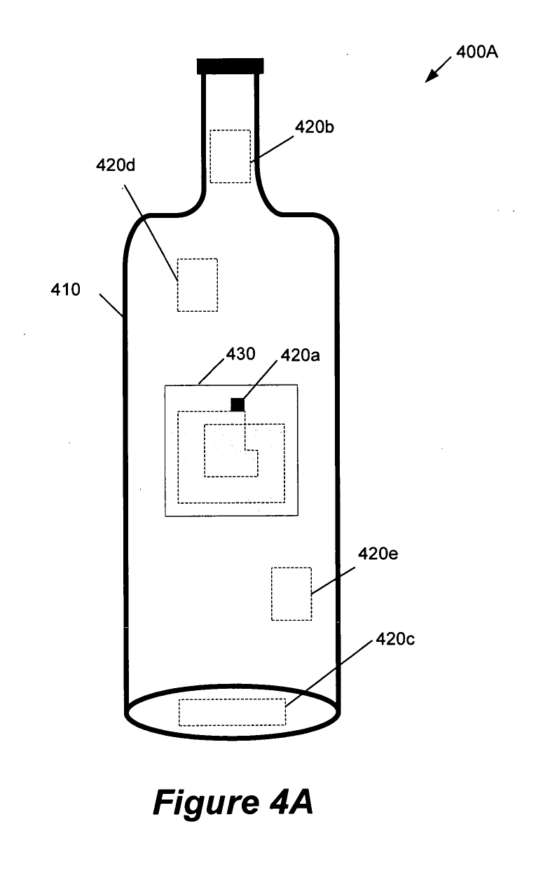

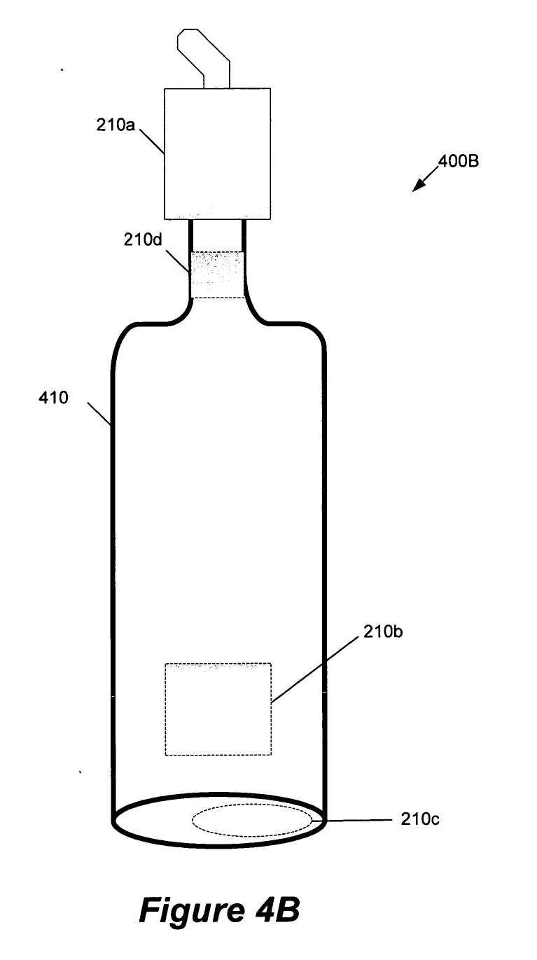

FIG. 4A conceptually illustrates a beverage container 400 as used in some embodiments of the invention. Although a bottle is shown in FIG. 4, a person of ordinary skill in the art will realize that other containers for beverages (e.g., a cask or barrel) can also be used. In some embodiments, the beverage container may be a non-metallic (e.g., glass or plastic) bottle. In some embodiments, the container may also be metallic (e.g., a can or a metallic bottle). As shown in this figure, the beverage container 410 has a container label 430. Several alternate locations for an EID, illustrated as a RFID tag, are also shown in the figure. As shown, in some embodiments, the RFID tag 420a may be located over or under the container label 430. In some embodiments, the tag is fabricated as part of the label. In some embodiments, the tag may be located in other locations on the outside or inside of the container, not associated with the label, such as on the neck (420b) or on the bottom (420c), or on the side (420d and 420e). In some embodiments, the tag is fabricated as part of the container, e.g., embedded in part of a glass or plastic container.

The tag is of a type compatible with an RFID reader contained in the PMD 210, scanning pads 215, container receptacles 220, and discard receptacles 223. The IC chip on the tag has been programmed by the beverage manufacturer with certain information describing, e.g.,
A unique identification number
Manufacturer name/ID
Manufacturing site
Type of liquid
Quantity of liquid in the container, e.g., in liters
Date/time of manufacture

In some embodiments, the container tag 420 may be written to as well as read. In such an embodiment, an unused area of tag data storage is reserved for the container wholesaler or retailer to write their own information, such as the time and date of each pour (a date/time stamp), temperature, humidity, warehouse identification number, storage locker room identification, identification of a person pouring liquid or handling the container.

In some embodiments, the tag is manufactured along with the container. In other embodiments, the tag is affixed to the container by a wholesaler or retailer at the wholesale or retail location upon receipt of a shipment of containers. In other embodiments, the tag is affixed to the container by a manager or by a beverage sales person when the container is placed in par storage or just before use.

2. PMDs

FIG. 4B conceptually illustrates a beverage container 400B as used in some embodiments of the invention. As shown in this figure, the beverage container 410 has PMD 210a, and alternate locations for PMDs 210b, 210c, and 210d.

In some embodiments, PMDs are attached to a container but do not monitor or pass liquid flow out of the container. In these embodiments, the PMD may determine that liquid flow occurs by an indirect means, such as measurement of container tilt angle. In other embodiments, a PMD, such as a spout, monitors but may or may not control liquid flow. In other embodiments, a PMD may monitor liquid flow but does not act as a spout. These variations on the embodiments of the PMD are further described below.

In some embodiments, the PMD is a pour spout 210a. Such a spout comprises an RFID tag reader and antenna for reading the container tags, described above, and other electronics for controlling or measuring liquid flow or a chronometer for measuring time of tilt, and for communication with an external system, such as an LCH. In other embodiments, the PMD 210b attaches to the side of the container by, for example, a strap or an adhesive. In these embodiments, the PMD does not measure or control liquid flow. Instead, the amount poured is estimated by the time the container is tilted, as measured by a sensor in the PMD and communicated to an external system. This process is described in more detail below. In another embodiment of a PMD, the PMD functions are similar to the side-mounted PMD, except that the PMD 210c is affixed to the bottom of the container. The PMD may be mounted to the container by a clip, an adhesive or as a cup that is attached to the bottom of the container. In addition to the functions of the side-mounted PMD, the bottom-mounted PMD, in some embodiments, also detects when the bottle is picked up or set down.

In some embodiments, a PMD is part of a liquid dispensing system. In such a system, a container, such as a bottle, is inverted into a pumping system located in a storage area. Liquid from the bottle is pumped to a dispensing gun at the point of sale, such as a bar. A PMD local to the pump reads the tag on the bottle and sends the tag information to an LCH. In some embodiment, another PMD in the dispensing gun reads the beverage salesperson's PIT and sends data such as the PIT read, amount poured, and time/date to an LCH.

In some embodiments, a PMD attaches to a portion of the container allowing it to monitor the flow of liquid out of the container. For example, the PMD 210d may be attached to or surround the neck of a bottle where it can monitor the flow or the presence of liquid through a constricted area. In this manner, the PMD can measure the quantity of liquid used for the pour or simply tell that a pour is occurring.

In some embodiments, a PMD 210 has an RFID tag. This tag may be read by, for example, a scanning pad 215 or a container receptacle 220. By reading the PMD tag, it is possible to account for the use and placement of the PMD, and thus track improper removal by personnel.

After a container is opened by a sales person, he or she takes a PMD 210 from a set of unused PMDs and installs it onto the container. In some embodiments where the PMD is a spout, the spout is installed onto an opening (such as the mouth of a bottle) of the container 410. When the PMD is placed on the container, the PMD sends a message to the LCH 205 with its serial number (ID) and that it has been placed on a container.

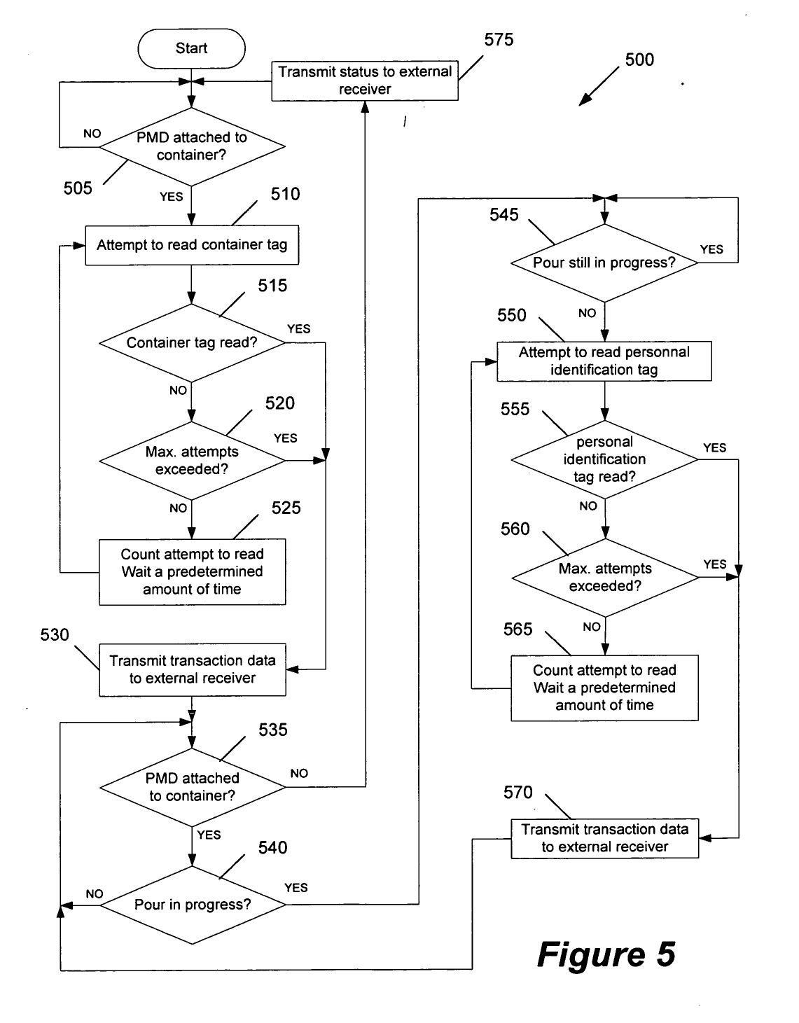

FIG. 5 illustrates the operational process 500 of a PMD of some embodiments. As shown in this figure, the process starts at 505 by continuously checking for the PMD being attached to a container. If the PMD is attached to a container, then the PMD attempts to read the container tag (at 510). If the read is not successful (at 515), then a count of attempts is checked (at 520). In some embodiments, the PMD does not maintain a maximum number of attempts and continuously attempts to read the tag until the read is successful (i.e., the process 500 does not perform steps 520 and 525 and proceeds back to 510 if the read is not successful). If the maximum has not been exceeded, then the read attempt is counted (at 525) and, after a predetermined amount of time, the process returns to 510 to attempt the read again. If either the read is successful (at 515) or the maximum allowed number of attempts has been exceeded (at 520), the process stops attempting to read the container tag and transmits (at 530) this status to an external receiver (such as the LCH). The status information includes the PMD's unique identifier and the container's unique identifier. This information allows the data manager 110 to relate subsequent pour data from the PMD to the particular container from inventory and the type of beverage it contains. This automated information collection process enables the data manager to track pours without relying on manual association of PMDs and containers.

Next (at 535), the process checks whether the PMD is still attached to the container. If the PMD is no longer attached to the container, then this status is reported at 575 and the process starts polling for attachment again, at 505. In some embodiments, the status includes the following transaction data: (1) the container ID read, (2) PMD off a container, and (3) a date/time stamp. Otherwise, the process checks (at 540) for a pour in progress. For instance, as described above, in some embodiments, a pour condition is determined from the angle of tilt of the container (e.g., a tilt angle greater than 90 degrees from vertical). If no pour is in progress, then the process proceeds back to 535. Otherwise, when a pour condition is detected, the process proceeds to 545 and waits for the pour to be completed.

When the pour is no longer in progress, the process attempts to read (at 550) the personal ID tag of the beverage sales person holding the container. If the read is not successful (at 555), then a count of attempts is checked (at 560). If the maximum has not been exceeded, then the read attempt is counted (at 565) and, after a predetermined amount of time, the process returns to 550 to try the read again. If either the read is successful (at 555) or the maximum allowed number of attempts has been exceeded (at 560), the process stops attempting to read the container tag and transmits (at 570) the status to an external receiver. The process then proceeds to 535 which was described above. In some embodiments, the status includes the following transaction data: (1) the personal ID read or bad read, (2) the container ID read or bad read, (3) pouring status, and (4) a date/time stamp.

Total volume of liquid poured is estimated based on one of at least three categories of beverage dispensing: (1) free-pour methods in which liquid flows from the spout any time the container is sufficiently tilted, (2) portion control or controlled pour methods in which the spout can independently stop or allow the flow of liquid, and (3) computer estimated methods.

In some embodiments using a free-pour spout, the data manager 110 estimates the amount poured using a process based on liquid volume per unit time. That is, the total volume of liquid poured may be derived from the known viscosity of the particular liquid (volume/time) multiplied by the time duration of the pour. Specifically, the data manager 110 first obtains the type and brand of beverage in a container from data reported by the spout. The data manager uses this information to look up the viscosity of the particular liquid in the data store 120. After the pour has been completed, as described in FIG. 5, step 570, data is transmitted that includes the total time of the pour. As described above, the data manager can then combine the known viscosity with the total time to derive the amount of the pour.

In some embodiments, the PMD 210 only reports the events of the beginning and end of a pour and the data manager 110 counts elapsed time between the events. In other embodiments, the PMD counts time itself (e.g., using an internal chronometer) and reports the total time at the end of the pour. In some embodiments, other methods for estimating volume poured are used. For instance, the PMD may continuously or periodically report the angle of tilt and the data manager uses this angle to estimate fluid flow rate.

In some embodiments using a portion control spout, the beverage sales person sets the spout 210 for the amount of liquid needed from the pour per the recipe for the drink he is making. When the container is tilted, the spout opens for the predetermined amount of time or meters out the needed volume and then closes when the required volume has been dispensed. The sales person returns the container to the non-pour condition after the spout closes. When the pour is completed, the spout transmits the amount poured in step 570 of FIG. 5.

In other embodiments, the data manager 110 may use one of several computer estimated methods to derive pour volume. While in some embodiments, the electronics implementing these methods may be contained in a spout, the methods also apply to embodiments with PMDs other than spouts. In one embodiment, the method is based on a number of assumptions: (1) containers are used from a completely full to a completely empty state, (2) the initial volume of the container is known from its type and brand, (3) the number of pours is known, and (4) the amount of each pour is known from the type of drink it is used in. In this method, the PMD 210 only reports the discrete event that a pour occurred. After all pours from a container have been completed and reported by the PMD, and the container is read by the discard receptacle 223 as discarded, the data manager extrapolates the average pour amount for the life of the container. This computer estimated method can be reasonably accurate in the aggregate but is less so per pour than the free-pour or portion control methods. However, the computer estimate can be improved after all pours from a container have been counted. This is accomplished by subtracting a small amount from each assumed volume per pour to correct the total of all pours to the known total volume of the full container.

In another embodiment of a computer estimated method, the amount of liquid for each pour from a container is estimated after all pours have been completed from the container. The PMD 210 attached to the container sends a signal to the LCH 205 at the start and end of each pour. The LCH sends this data to the data manager 110 which stores this data for later computation. The data manager also receives confirmation from a discard receptacle 223 when the container has been discarded (and assumed to be empty). After the container has been emptied, the data manager computes the amount of each pour as a percentage of the total original contents of the container. The percentage for each pour is assumed to be the same as the percent of the associated pour time with respect to the total of all pour times. For example, given the following assumptions:
The total size of the container is 33.8 ounces
The container was poured ten times before discard
The total time for all ten pours reported by the PMD is 100 seconds
The fourth of ten total pours from the container took 10 seconds

Then the fourth pour took 10% of the total time and, therefore, it is assumed that the pour consumed 10% of the total contents of the container, or 3.38 ounces. Thus, the data manager 110 updates the data store 120 with the amount of 3.38 ounces for the fourth pour.

In some embodiments, the PMD is attached and/or removed from the container only by a manager using a mechanical device in some embodiments or an electronic key in other embodiments. If a beverage sales person is restricted from attaching or removing PMDs, then all of the containers in par stock would be pre-equipped with PMDs by a manager who would also remove PMDs from depleted containers.

Proper operation of PMDs 210 is important to maintain accurate tracking of beverage dispensing. Some embodiments of the beverage dispensing and sales tracking system use one or more of at least two methods to determine if any PMD has failed: (1) periodic statusing and (2) roll call. In the first method, each PMD periodically transmits its status or “heartbeat” based upon an internal chronometer. The data manager, through the LCH 205, expects to receive this status at the known periodic rate. If several periods go by without receiving this status from a PMD, the data manager can alert beverage sales persons in the sales area where the PMD was last used that the particular PMD is no longer functioning and should be replaced.

In the second method, the LCH 205 or the data manager 110 via the LCH, periodically polls each PMD 210 for status. If proper status is not returned after several attempts, the PMD is assumed to be non-functional and is noted for replacement. Unlike the first method where the PMDs independently transmit their status, this roll call method requires that each PMD has both a transmitter and a receiver circuit but does not require each PMD to have a chronometer. Other embodiments may use a combination of these methods or other means to periodically verify proper operation of PMDs.

3. Scanning Pads

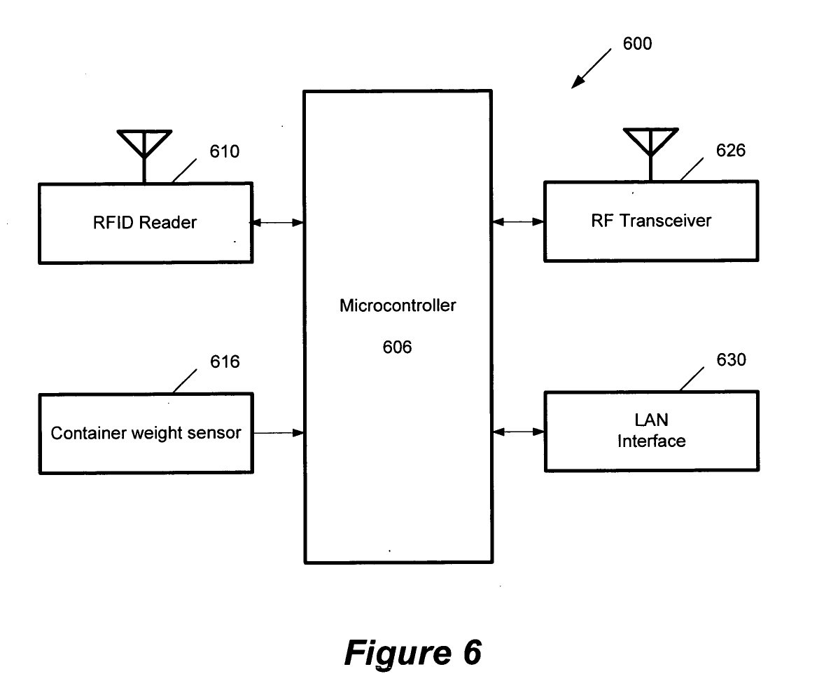

The system also utilizes scanning pads to collect data regarding the location of containers. FIG. 6 illustrates a block diagram 600 of a hardware implementation of a scanning pad of some embodiments. The scanning pad includes a microcontroller 605, an RFID reader 610, a container weight sensor 615, an RF transceiver 625, and a wired or wireless LAN interface 630. The microcontroller includes memory and a time/date clock. When a container is placed on the scanning pad, its weight is read by the weight sensor 615 which signals the microcontroller 605 that a container is present. In some embodiments, a scanning pad only includes either the RF transceiver 625 or a LAN interface 630.

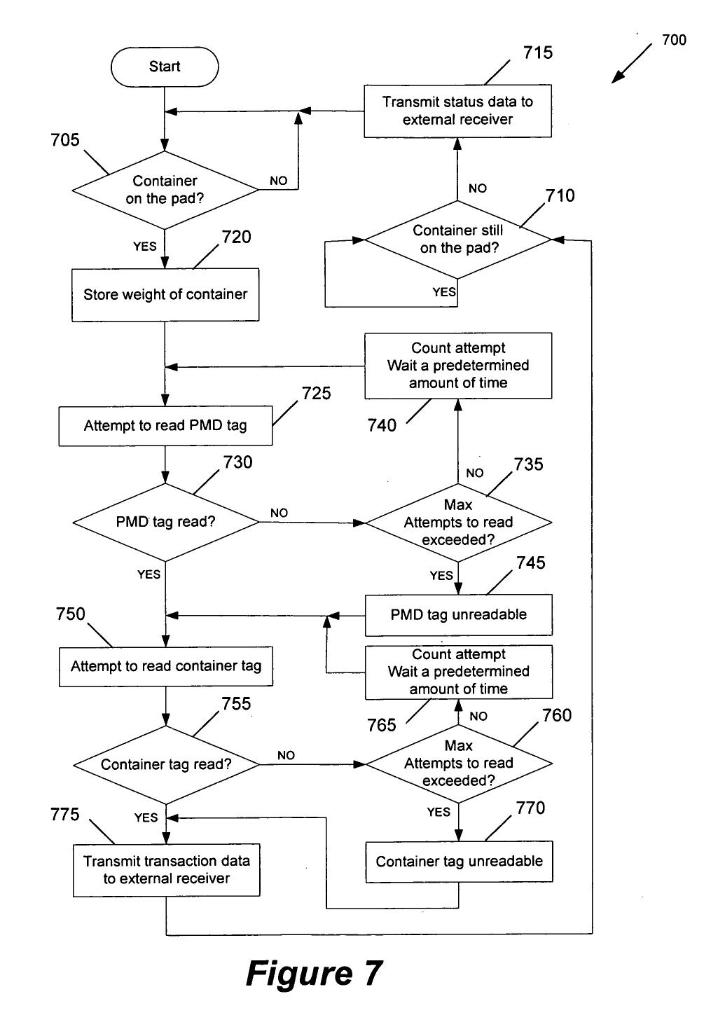

FIG. 7 illustrates a scanning pad process 700 of some embodiments. As shown in this figure, the process checks (at step 705) whether a container is on the scanning pad by reading the weight sensor 615. If not, then the process loops back to 705. Otherwise, if a container has been placed on the pad, then, in some embodiments, the weight of the container is stored (at 720). In other embodiments, where the weight is not stored, step 720 is skipped. The process then attempts to read (at 725) the identification of the PMD 210 attached to the container. In some embodiments, the PMD identification is internally kept in the PMD. In some embodiments, the PMD includes an RFID tag identifying the PMD.

If the read is not successful (at 730), then a count of attempts is checked (at 735). If the maximum has not been exceeded, then the read attempt count is incremented (at 740) and, after a predetermined amount of time, the process returns to 725 to try the read again. If the read is successful (at 730), then the process attempts to read the container tag (at 750). If the process determines (at 755) that the read is successful, then the process proceeds to 775, which is described later. If the read is not successful (at 755), then a count of attempts is checked (at 760). If the maximum has not been exceeded, then the read attempt count is incremented (at 765) and, after a predetermined amount of time, the process returns to 750 to try the read again. If the maximum has been exceeded, then the process stops attempting to read the container tag and notes (at 770) an unreadable tag condition in memory. The process transmits (at 775) status and transaction data to an external receiver. In some embodiments, the status includes the following transaction data: (1) the ID of the container, (2) the ID of the PMD, (3) the weight of the container, (4) container tag readable or unreadable, and (5) a time/date stamp.

The process then checks (at 710) if the container is still on the pad. If it is, then the process loops back to 710 and waits until the container is removed. When the container is removed from the pad, status information is transmitted (at 715) to an external receiver. In some embodiments, the status includes the following data: (1) the ID of the container or bad read, (2) the ID of the PMD or bad read, (3) container on or off of the pad, and (4) a time/date stamp.

4. Container Receptacles

As shown in FIG. 2, in addition to scanning pads 215, the pour tracking process also utilizes container receptacles 220. Container receptacles store unopened containers in par stock, ready for use by beverage sales persons. A container receptacle includes several locations where containers can be inserted for storage. In some embodiments, a container receptacle has similar components as the scanning pad. When a container is placed in or removed from a receptacle storage location, a process similar to that of FIG. 7 reads the PMD and container tags and sends this information to the external receiver (e.g., the LCH 205). The LCH passes this information to the data manager which, as described above, uses the information to establish the location of each container.

In some embodiments, the container receptacle will not release a container to an unauthorized person. The container receptacle attempts to read a PIT each time a container in the receptacle is lifted for removal. The data read from the PIT or the inability to read any PIT is sent to the data manager 110. The data manager verifies that the PIT is valid and authorized for the sales location and time and, if so, authorizes the receptacle to release the container. If authorization is denied, then the receptacle will mechanically not allow the container to be fully removed from the container receptacle. This authorization/release method helps prevent unauthorized use or pilferage of the containers.

5. Discard Receptacles

In some embodiments, life cycle tracking of containers requires the data manager 110 to know when each container has been emptied and then discarded. As shown in FIG. 2, one or more discard receptacles 223 in each sales area provide a location for beverage sales persons to discard depleted containers. In some embodiments, each discard receptacle has an RFID reader located in the receptacle such that when a container is discarded, its tag 235 is read independent of any other containers that were previously discarded. The tag information is passed on to the data manager via the LCH. The data manager 110 uses the tag information and information from the data store 120 to verify the identity of the container and note it as depleted.

The contents of the discard receptacles 223 are eventually collected for disposal. In some embodiments, the container tags are read once more during disposal to verify that the container left the premises. In other embodiments, a container tag 235 may be rewritten either to prevent subsequent fraudulent reuse or, in the case of reusable containers, to re-identify the container after it has been recycled with new contents.

6. Secondary Data Devices

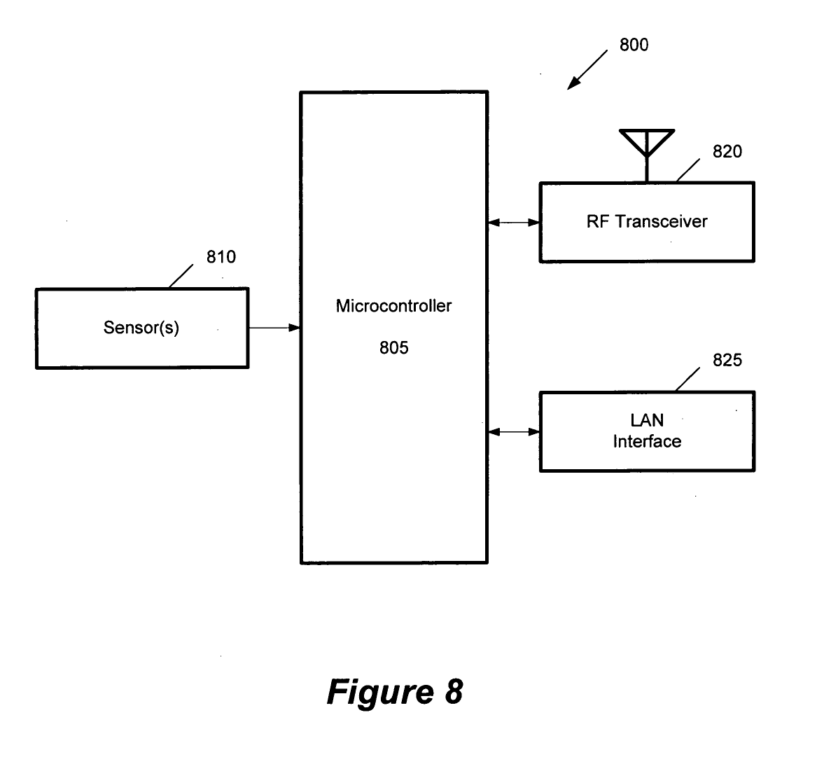

Some beverages, such as milk or wine, must be stored in well-controlled conditions to prevent spoilage or degradation. The LCH 205 collects data from secondary data devices to provide the data manager 110 with information concerning, for instance, the environmental conditions of beverage storage areas. FIG. 8 illustrates a block diagram 800 of a secondary data device of some embodiments. As shown in this figure, a data device includes a microcontroller 805, one or more sensors (such as temperature or humidity) 810, an RF transceiver 820, and a wired or wireless LAN interface 825. In some embodiments, a secondary data device only includes either the RF transceiver 820 or a LAN interface 825.

The microcontroller 805 collects data from the temperature and/or humidity sensors 810 and periodically sends this data to the LCH 205. In some embodiments, transmission of data is either wirelessly via the RF transceiver 820 or by a wired or wireless LAN interface, 825. In some embodiments, the secondary data device periodically reads the sensor(s) 810 and sends the data to the LCH. In other embodiments, the LCH may request data from the data device, at which time the data device reads and transmits sensor data.

Some embodiments, a secondary data device may include only one type of sensor, for instance, to measure temperature. In other embodiments, it may include multiple types of sensors, including temperature, humidity, or other sensors, depending on the environmental conditions to be monitored. In some embodiments, a secondary data device may have a chronometer to measure and report time and date.

7. Personal Identification Tags

Another component of the pour tracking process is reading personal identification tags (PITs). PITs are RFID tags carried by beverage sales persons (e.g., bar tenders or beverage sales persons) by one or more means. For example, a PIT may be embedded in:
A bracelet (a pair, worn one on each wrist, if the beverage sales person pours with either hand)
A shirt
A hat
An apron, etc.

The RFID tag contained in a PIT is pre-programmed with data that includes: (1) the person's employee ID and (2) his/her work schedule and location. In some embodiments, the PIT is read by the PMD each time the beverage sales person makes a pour, identifying that an authorized person poured the drink and what beverage sales person's account to charge the pour to, as further described above.

The data manager 110 uses PIT information to (1) verify that an authorized person made the pour, (2) verify the location of the pour from the work location of the beverage sales person. In some embodiments using a portion control spout, the spout will not release any liquid without a verification signal from the data manager indicating that the beverage sales person is authorized to make the pour. This information aids the data manager in either preventing or at least accounting for fraudulent pours by beverage sales persons who, to encourage a larger tip may either:
Pour too much
Ring up a low-cost well liquid after pouring an expensive brand

The data manager can aid in recognition of these kinds of problems by using PMD-reported information to determine:
Which PMDs are mated to which containers
If the container was brought in from outside the establishment by a beverage sales person
If PMDs are switched between containers
Where the pour occurred
If the pour got rung up on a POS terminal
If a beverage sales person pours from his own container and keeps the cash—the container tag will not match one from storage
If a beverage sales person takes a container from backroom storage or from par storage
If a container is removed from the premises

### III. Tracking the Life Cycle of a Container

An advantage of the system for beverage dispensing and sales tracking, described above, is its ability to accurately track all of the events in the life cycle of a container. These events include receipt by the sales establishment from a wholesale vendor, use of the contents of the container, and discard of the container when it is empty,

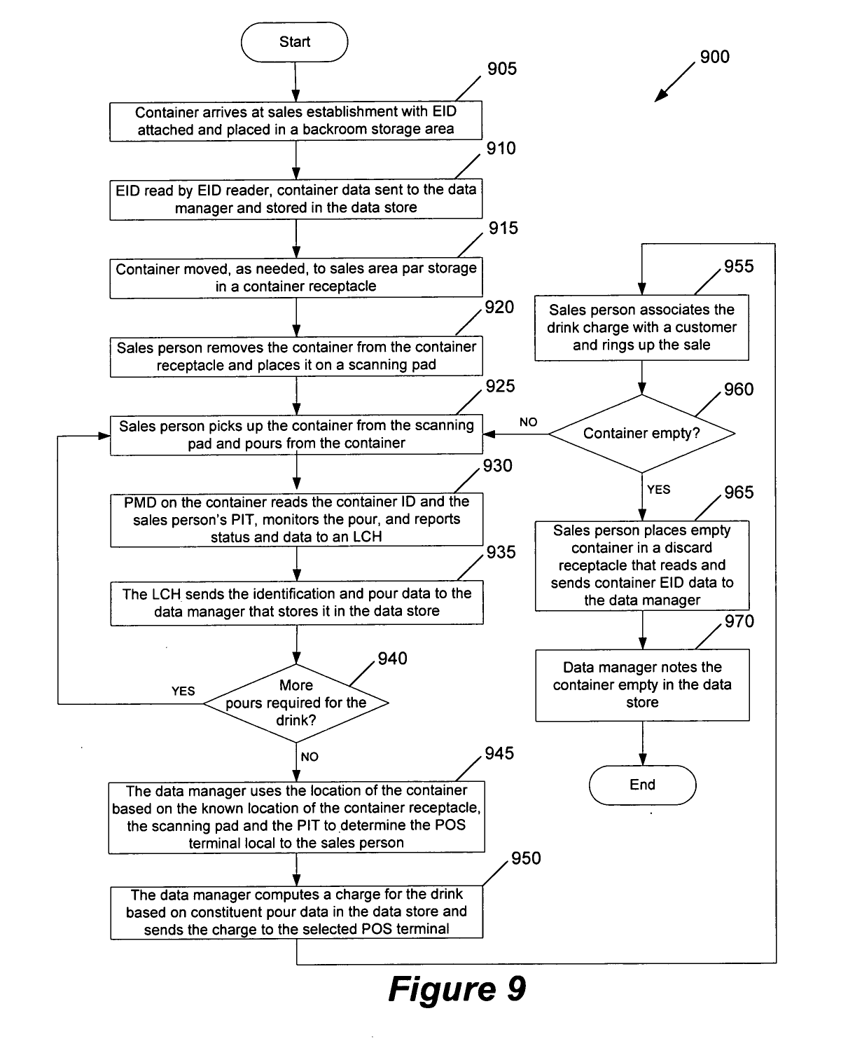

FIG. 9 illustrates a process 900 used by the data manager 110 of some embodiments to track the life cycle (or usage cycle) of a container. Tracking starts at 905 when a container arrives, as part of a shipment of containers, at the sales establishment. The container has an EID attached by the manufacturer or wholesaler, as described above. As described above, in some embodiments, the EID is an RFID tag. The container is moved to a backroom storage area and the EID is read (at 910) by an inventory RFID tag reader. The data read is sent to the data manager 110 that stores the data from the container's EID in the data store 120. In some embodiments, the ambient temperature and humidity of the backroom storage area is monitored by a secondary data device 245 and the temperature and humidity data is sent to the data manager. Subsequently, when a sales area needs to be restocked, the container is moved (at 915) from the storage room to par storage in a container receptacle 220 in a sales area. When the container is placed in the container receptacle, the receptacle reads the container's EID and sends the data to the data manager, which uses the data to locate the container as being in the sales node 130. In some embodiments, the temperature and humidity of the container receptacle is also monitored by a secondary data device.

When a beverage sales person needs the container as a constituent part of making a drink, she removes (at 920) the container from the container receptacle, and places it on a scanning pad 215 at her work area. Removing the container from the container receptacle causes the receptacle to send status data to the data manager that the container has been removed. Placing the container on the scanning pad causes the pad to read the container's EID and send the data to the data manager, thus further locating the container at the point of use. When the sales person mixes a drink, she picks up (at 925) the container from the scanning pad, and pours from it. When the container is poured, in some embodiments, as alternately described above, a PMD on the container reads (at 930) the container's EID as well as the PIT of the sales person. The PMD then sends the pour and identification data to the data manager via the LCH 205. The LCH sends (at 935) the data to the data manager that stores it in the data store. If it is determined (at 940) that more pours from the same container or different containers are needed to complete the drink, then the process loops through step 925 to make the pour and send additional data to the data manager.

If no further pours are required to complete the drink, then the data manager uses (at 945) the collected data including the location of the container, based on location reported from the container receptacle 220, the scanning pad 215, and the PIT data to determine a POS terminal local to the sales person who poured the drink. The data manager then computes (at 950) the total price and cost of the drink, sending the price to the POS terminal and storing the cost against inventory in the data store. The sales person then associates (at 955) the drink with a particular customer account and rings up the sale.

If the container becomes empty (at 960), then a sales person will discard it (at 965) by placing it into a discard receptacle 223. The discard receptacle reads the container's EID and reports the data to the data manager. Finally, the data manager notes (at 970) in the data store that the container has been emptied. In some embodiments, the data manager uses this event to compute the estimated size of each pour from the container, as described above.

### IV. Alternate Embodiments

A. Scanning Pad Capabilities

In some embodiments, the data manager 110 receives data from an LCH 205 immediately after the LCH acquired the data. In other embodiments, the LCH has a store and forward capability in which it acquires data and stores it in a local memory until the data manager requests it. This store and forward process provides protection of pour and container tracking data if the data manager computer is not operating or communicating with an LCH for some period of time.

In some embodiments, a scanning pad, after weighing a container, writes the weight as well as a date/time stamp, sequence number, etc. to a container tag. In some embodiments, a scanning pad is interfaced to a numerical display, visible to beverage sales persons, to provide the beverage sales persons with training feedback as to the amount poured for each pour. This allows them to learn to more accurately make each pour.

B. Container Receptacle Capabilities

In some embodiments, the container receptacle includes a memory used to store data representing container insertions and removals, as described above. In some embodiments, a container receptacle, after weighing a container, writes the weight as well as a date/time stamp, sequence number, etc. to a container tag. In some embodiments, the data manager 110 periodically queries the LCH(s) for data accumulated in the LCH(s) between queries. Storing the data between queries for the data by the data manager prevents data loss if an LCH or the data manager is busy or out of service while container insertions and removals occur. The data manager can query the container receptacle for the accumulated data, and the receptacle will forward the data to the data manager at that time.

C. RFID Tag Shielding

In some embodiments, the scanning pad includes a RF shield around the pad in such a way that shields adjacent container's tags from the pad's RFID reader. The shield prevents incorrect reads of containers on the pad due to interference from adjacent containers that are not on the pad.

In some embodiments, the ability of the PMD 210 to read the RFID tag 420 without interference from other tags and readers may be enhanced. Extraneous RF fields may be reduced by a transparent RF-reflecting material applied on top of the container label 430, and thus covering the area over the antenna of the RFID tag. By this means, the RF field between the tag and the PMD RFID reader antenna inside the container 410 is not reduced but fields between the antenna and external sources are reduced. Thus, the PMD reader can more reliably read the container tag.

D. RFID Tag Proximity Determination

In some embodiments, some RFID readers in the system can analyze the returned RF signal response from an RFID tag to determine the relative distance from the reader to the tag. The reader sends an RF signal to the tag and simultaneously starts a clock. When the signal from the tag is received, the clock is stopped and the time-of-flight of the signal is calculated. The distance to the tag is then computed as the speed of light, c (approximately 186,000 miles per second), times the measured time in seconds. Thus, if, for example, the clock has a resolution of one nanosecond, then the distance from the reader to the tag can be estimated to an approximate one foot resolution.

E. RFID Tag Movement and Direction Determination

Accurately tracking the movements of beverage inventory into and out of receiving, storage and serving areas can enhance the ability of the system to reconcile beverage usage and cash flow. It can also help prevent theft by tracking containers improperly taken out of storage.

In some embodiments, some RFID readers in the system can determine the physical direction that tagged items are moving, for example, into or out of a room. Two or more readers A and B are placed at a non-interfering distance apart at the entrance of a room. When a tagged item passes by, it is read by both readers, in sequence. The sequence of reads, that is, A before B or B before A, determines if the tagged item is entering or leaving the room. In some embodiments, more than two readers are used to determine if a container is moved from one area to another.

If a timer is started when the first reader reads the tag and stopped when the second reader reads the tag, then the speed at which the tagged item moved between the readers can be determined by the following equation:

$$Tag speed = \frac{distance between readers}{( time of {1}^{st} read ) - ( time of {2}^{nd} read )}$$

### V. Computer Systems

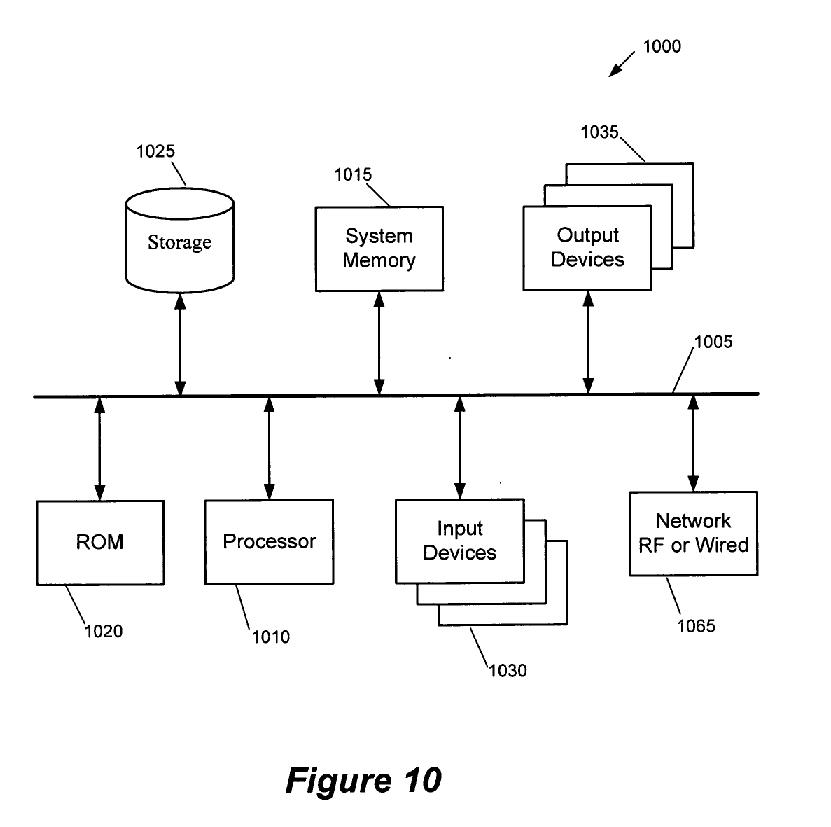

FIG. 10 conceptually illustrates a computer system with which some embodiments of the invention are implemented. Computer system 1000 includes a bus 1005, a processor 1010, a system memory 1015, a read-only memory 1020, a permanent storage device 1025, input devices 1030, and output devices 1035. Specifically, FIG. 10 illustrates components of a data manager 110, LCH 205, or POS terminals 230, with the differences in I/O devices 1030 and 1035.

The bus 1005 collectively represents all system and peripheral devices, and the buses that support communication among those devices of the computer system 1000. For instance, the bus 1005 communicatively connects the processor 1010 with the read-only memory 1020, the system memory 1015, and the permanent storage device 1025.

From these various memory units, the processor 1010 retrieves instructions to execute and data to process in order to execute the processes of the invention. The read-only-memory (ROM) 1020 stores static data and instructions that are needed by the processor 1010 and other modules of the computer system. The permanent storage device 1025, on the other hand, is a read-and-write memory device. This device is a non-volatile memory unit that stores instruction and data even when the computer system 1000 is off. Some embodiments of the invention use a mass-storage device (such as a magnetic or optical disk and its corresponding disk drive) as the permanent storage device 1025. Other embodiments use a removable storage device (such as a floppy disk or zip® disk, and its corresponding disk drive) as the permanent storage device.

Like the permanent storage device 1025, the system memory 1015 is a read-and-write memory device. However, unlike storage device 1025, the system memory is a volatile read-and-write memory, such as a random access memory. The system memory stores some of the instructions and data that the processor needs at runtime. In some embodiments, the invention's processes are stored in the system memory 1015, the permanent storage device 1025, and/or the read-only memory 1020.

The bus 1005 also connects to the input and output devices 1030 and 1035. The input devices enable the user to communicate information and select commands to the computer system. For the data manager, the input devices 1030 include alphanumeric keyboards and cursor-controllers. The output devices 1035 display images generated by the computer system. The output devices include printers and display devices, such as cathode ray tubes (CRT) or liquid crystal displays (LCD).

For the LCH 205, the input devices 1030 include RF transceivers to communicate with PMDs, and a keypad for local setup and diagnostic use. The output devices 1035 for an LCH include a display for use with the keypad for local interaction. For the POS terminal 230, the input and output devices 1030 and 1035 include a cash register, a display device, such as a CRT or LCD, a touch screen, and a printer.

Finally, as shown in FIG. 10, bus 1005 also couples computer 1000 to a network 1065 through a network adapter (not shown). In this manner, the computer can be a part of a network of computers (such as a local area network (“LAN”), a wide area network (“WAN”), or an Intranet) or a network of networks (such as the Internet). Any or all of the components of computer system 1000 may be used in conjunction with the invention. However, one of ordinary skill in the art will appreciate that any other system configuration may also be used in conjunction with the invention.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

What is claimed is:

1. A method for tracking pours from a beverage container, the method comprising reading an electronic identification device (EID) attached to the container.

2. The method of claim 1, wherein the method obtains pour tracking data from a pour monitoring device (PMD) attached to the container that reads data from the EID.

3. The method of claim 2, wherein the PMD monitors the amount of liquid poured from the container.

4. The method of claim 2, wherein the PMD reads a personal identification tag (PIT) identifying the person pouring from the container.

5. The method of claim 1, wherein the EID is a Radio Frequency Identification (RFID) tag.

6. The method of claim 3, wherein the amount of liquid poured from a beverage container is determined by:
a) waiting for the container to be tilted beyond a particular angle;
b) accumulating a time interval that the container is tilted beyond the particular angle; and
c) computing the amount of liquid poured based on the time interval and viscosity of the liquid.

7. The method of claim 3, wherein the PMD is a spout, the spout measuring the amount of liquid poured from a beverage container, the measurement comprising:
a) setting the spout for a particular amount to be poured by the beverage sales person;
b) waiting for the container with the spout to be tilted beyond a particular angle; and
c) outputting data based on the particular amount from the spout when the container is returned to an angle less than the particular angle.

8. The method of claim 3, wherein monitoring the amount of liquid poured comprises:
a) waiting for the container to be tilted beyond a particular angle;
b) accumulating a number of pours from the container based on the number of times the container is tilted beyond the particular angle; and
c) estimating the amount of liquid poured based on the amount of liquid in a full container and the number of pours from the container.

9. The method of claim 3, wherein the monitoring the amount of liquid poured comprises:
a) waiting for the container to be tilted beyond a particular angle;
b) accumulating the time duration of each of a number of pours from the container; and
c) estimating the amount of liquid poured for each pour based on the amount of liquid in a full container, the number of pours from the container, and the time duration of each pour from the container.

10. The method of claim 6, wherein the viscosity of the liquid is determined by the type of the liquid in the container, brand of the liquid in the container, and size of the container.

11. The method of claim 8, wherein the amount of liquid in a full container is based on size of the container.

12. The method of claim 9, wherein the amount of liquid in a full container is based on size of the container.

13. A system for tracking the usage cycle of a beverage container, the system comprising:
a) a set of sales nodes, each sales node having a set of beverage containers, each beverage container uniquely identified by an electronic identification device (EID);
b) a data store for storing usage cycle data;
c) a data manager for communicatively coupling the sales nodes to the data store to store usage cycle data for the container in the data store; and
d) a plurality of pour monitoring devices (PMDs) in at least one sales node, wherein PMDs are for attaching to the container, wherein said PMDs are for reading the EIDs of the containers.

14. The system of claim 13, wherein the usage cycle of each container includes the time and date of receipt of the container.

15. The system of claim 13, wherein the usage cycle of each container includes the amount of liquid removed from the container each time the container is poured.

16. The system of claim 13, wherein the usage cycle of each container includes the time and date of discard of the container.

17. The system of claim 13, the sales nodes further comprising:
a) a set of container receptacles;
b) a set of scanning pads;
c) a set of discard receptacles; and
d) a local communications hub for automatedly communicating data from the set of scanning pads, container receptacles and discard receptacles to the data manager.

18. The system of claim 17, wherein one of the set of container receptacles reads the EID of a container placed on the pad and sends the EID data to the data manager.

19. The system of claim 17, wherein one of the set of scanning pads automatedly reads the EID of the container placed on the pad and sends the EID data to the data manager.

20. The system of claim 17, wherein one of the set of discard receptacles reads the EID of the container when the container is placed in the discard receptacle and the receptacle sends the EID data to the data manager.

21. The system of claim 13, wherein the EID is a Radio Frequency Identification (RFID) tag.

22. The system of claim 13, wherein the PMD is a spout attached to the container.

23. The system of claim 13, wherein the PMD reads a personal identification tag (PIT) of the person pouring the beverage

24. The system of claim 23, wherein the PIT is located at one or more locations on the person pouring the beverage, the locations of the PIT on the person pouring the beverage including:
a) in an article of clothing;
b) in a wrist band.

25. The system of claim 12, wherein the PIT is a Radio Frequency Identification (RFID).
